(19) United States
(12) Patent Application Publication
(10) Pub. No.: US 2007/0063026 A1
(43) Pub. Date: Mar. 22, 2007

(54) Method and system for packaging and despensing samples in a sales environment

(76) Inventors: George Mamaropolos, Yorktown Heights, NY (US); Lekshmy Parameswaran, London (GB); Giang Vu, Ossining, NY (US); Clive R. van Heerden, London (GB); Jack Kyriakos Mama, London (GB)

Correspondence Address: PHILIPS INTELLECTUAL PROPERTY & STANDARDS, P.O. BOX 3001, BRIARCLIFF MANOR, NY, 10510, US

(21) Appl. No.: 10/575,520

(22) PCT Filed: Oct. 12, 2004
(86) PCT No.: PCT/IB04/52071

§ 371 Date: Apr. 13, 2006

Related U.S. Application Data
(60) Provisional application No. 60/511,137, filed on Oct. 14, 2003.

(51) Int. Cl. G06F 7/08

(52) U.S. Cl. 235/381

(57) ABSTRACT

The invention includes a system for, a method for, and a method of doing business including dispensing samples. These include a sample card distributor 4; a machine-readable label 3 incorporated in a sample card 2, a machine-readable label writer 6 for writing data associated with a product 5 onto the machine-readable label 3, and a device for distributing samples 7 which includes a machine-readable label reader 9 for reading the machine-readable label 3; a database 12 containing sample information; means for packaging and distributing samples 14; and a processor 11 for receiving data from the machine-readable label reader 9, obtaining sample information from the database 12, and directing the means for packaging and distributing samples 14 to package and distribute at least one sample.

The invention relates to environments, such as sales environments, where samples are distributed. The invention also relates to systems that employ machine-readable labels to store data and deliver them to readers when scanned.

Conventional sales environments have a constant flow of customers. One effective system of introducing new products to a given market is to provide customers with samples. Product samples are offered to customers either via dedicated sales assistants who manually distribute them, or they are distributed around a sales environment for customers to take as they please. Samples may include advertising information as well. The packaging and general presentation of the samples play an important role in attracting customers to a new product or establishment.

Currently a customer has some difficulty collecting, keeping, remembering, and carrying samples while they move through a sales environment. This may be due to the overwhelming number of samples, or the fact that many are discarded or lost as the customer moves about. Often, many samples are taken or forced upon a customer who may not desire the product the sample represents. A great deal of money is spent targeting potential customers of the new product or establishment. There exists a need in the art for a method and system of distributing samples in a more efficient and effective manner.

Various devices for encoding data currently exist and are under development. These devices generally permit objects to be tagged or labeled to permit machines to read and/or write data associated with the object. Radio-frequency identifier (RFID) tags deliver information by radio signals to a reader just as a transponder does. Similarly, a writer can transmit data wirelessly via radio signals that is stored on one or a plurality of RFID tags. One of the attractions of RFID devices is their potential to carry a large quantity of information. Other devices for storing information include printed and non-printed (e.g., etched) machine readable symbols (e.g., using a pattern recognition process) and digital watermarks.

RFID tags may be programmable and may also include sensors that can record various environmental factors into the tag.

Unlike printed samples, that are currently in use to market new products, which include only enough information as can be printed on a card (i.e., a very small amount of information), some machine-readable label (MRL) devices can store enough information to accomplish some very interesting things. For example, if attached to a product, it can uniquely identify that particular product, which could be tied in a central database to its date of manufacture, the shipment vessel it was conveyed in, its various elements, the seller to whom it was shipped, to whom it was sold, how it was manufactured, when, etc. Another advantage is that some are capable of being scanned by holding a reader some distance away and without precisely aiming the reader with respect to the MRL device. Some readers are capable or reading many MRL devices at once, for example RIFD readers.

According to the invention, in one aspect, a system for dispensing samples includes a sample card distributor. The system also includes a machine-readable label incorporated in a sample card, a machine-readable label writer for writing data associated with a product onto the machine-readable label, and a device for distributing samples which includes a machine-readable label reader for reading the machine-readable label; a database containing sample information; means for packaging and distributing samples; and a processor for receiving data from the machine-readable label reader, obtaining sample information from the database, and directing the means for packaging and distributing samples to package and distribute at least one sample.

In one embodiment, the machine-readable label includes a radio transponder or transmitter.

In another embodiment, the device for distributing samples further is a vending machine.

In another embodiment, the means for packaging and distributing samples also includes: at least one storage compartment for sorting and/or storing a sample; a mechanism for packaging the sample in a package; means for retrieving the sample from the storage compartment and transporting it to the mechanism for packaging; and a dispensing device for dispensing the packaged sample.

In another embodiment, the processor is programmable to receive data from the machine-readable label reader, obtain sample information from the database, and direct the means for packaging and distributing samples to package and distribute at least one sample. In another embodiment the processor initiates the device for distributing samples when the machine-readable label reader reads data written on a machine-readable label incorporated in a sample card.

Another aspect of the invention is a method for distributing samples that includes several steps. One step is distributing a machine-readable label. Another step is transporting the machine-readable label through an environment. Other steps are writing data associated with a product onto the machine-readable label; reading the data written on the machine-readable label; comparing the data written on the machine-readable label to a database; selecting at least one sample based on the comparing step; packaging the at least one sample; and distributing the at least one sample.

In one embodiment the method includes the step of programming a processor to initiate the reading step when at least one sample card is detected.

In another embodiment, the writing step includes writing information on the machine-readable label upon a manual request. In another embodiment, the writing step includes writing information on the machine-readable label automatically.

In another embodiment, the selecting step includes selecting based on the comparing step and upon programmed commands for selecting packaging and distributing the at least one sample.

In another embodiment, the packaging step includes packaging the at least one sample with additional materials. In another embodiment, the additional materials can include: advertising materials, coupons, promotional materials, graphics, messages, instructions for use, and/or additional sample cards.

Another aspect of the invention is a method of doing business that includes the following steps: incorporating a machine-readable label to a sample card; writing data associated with a product onto the machine-readable label; reading the data from the machine-readable label; comparing the data written on the machine-readable label to a database; selecting at least one sample based on the comparing step; packaging the at least one sample; distributing the at least one sample; and affecting the sale of goods or services based on sample distributed and the data written on the machine-readable label.

The invention provides many advantages, some of which are elucidated with reference to the embodiments below.

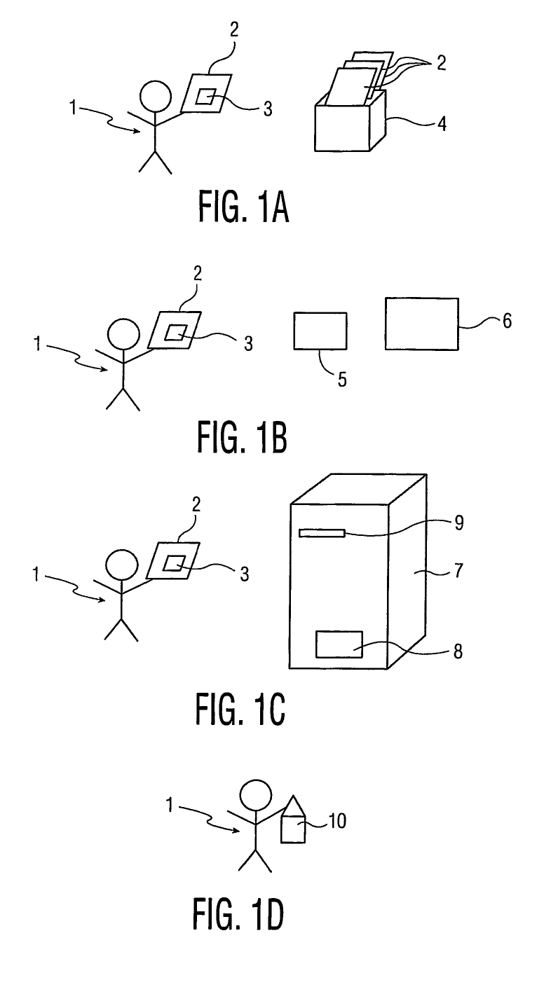

FIGS. 1A-1D are a depiction of a system for dispensing samples;

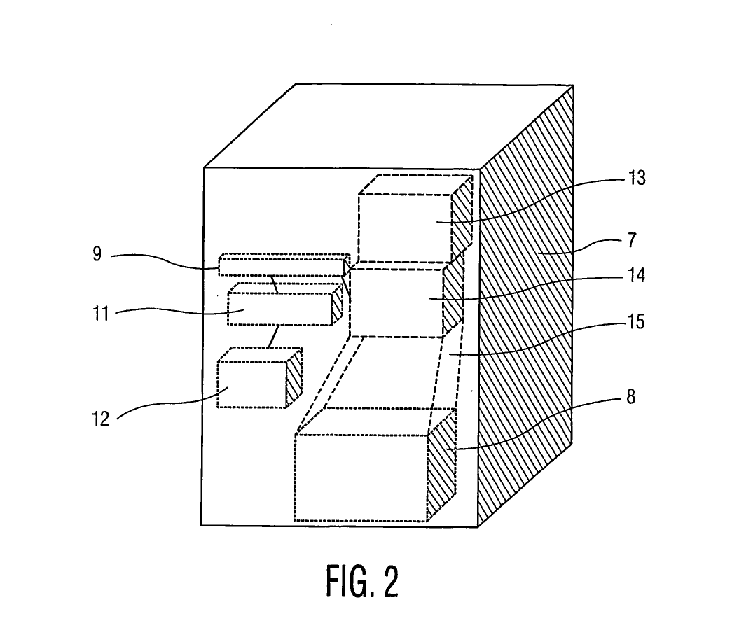

FIG. 2 is a depiction of a device for dispensing samples;

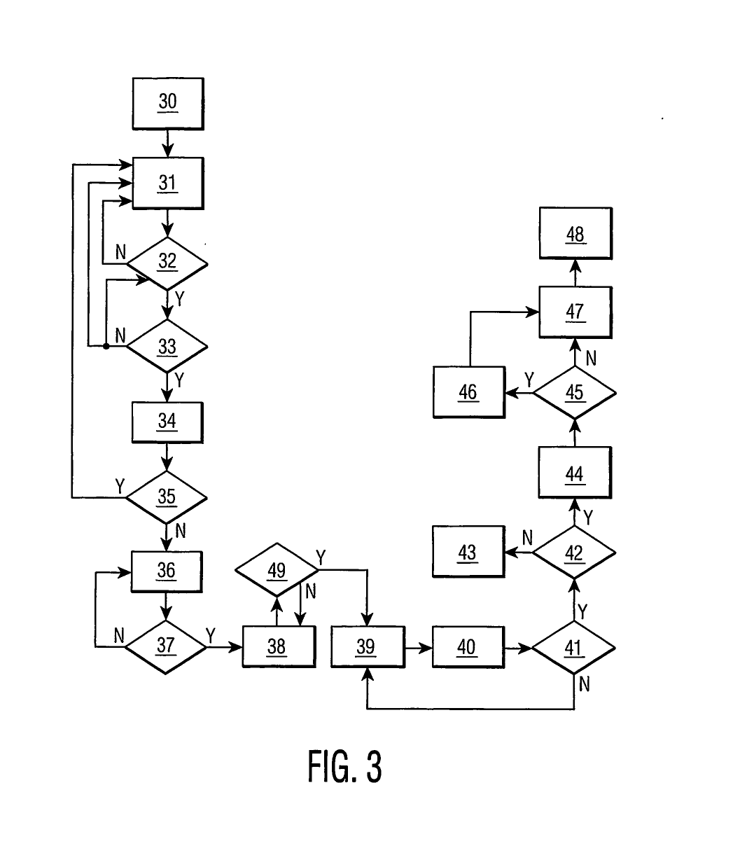

FIG. 3 is a flow chart of a method for dispensing samples;

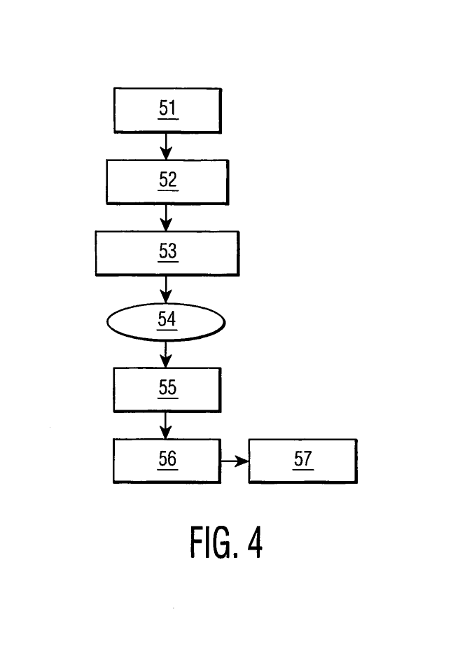

FIG. 4 is a flow chart of a method of doing business including a procedure for dispensing samples.

The proposed system and method provide for the dispensation of product samples from a sales environment, such as a department store.

FIG. 1A illustrates a preferred embodiment of the proposed system for dispensing samples. In this embodiment, a customer 1 selects a sample card 2 from a sample card distributor 4 (i.e., a card dispenser). The sample card 2 includes an affixed, inserted, or otherwise incorporated machine-readable label 3.

In FIG. 1B, customer 1 transports sample card 2 and machine-readable label 3 through a sales environment (not shown). Customer 1 sees a product 5 about which he or she is interested. Customer 1 may, for example, inquire about product 5 from a live salesperson or read information located on or near product 5. As an example, product 5 may be a new variety of perfume. Customer 1 may wish to try this new perfume. If upon trying the perfume, customer 1 wishes either additional information or a sample of product 5, he or she may then bring sample card 2 with incorporated machine-readable label 3 within range of a machine-readable label writer 6 for writing data associated with product 5 onto the machine-readable label 3. Data written onto machine-readable label 3 can be information about product 5, promotional information related to the supplier or manufacturer of product 5, or sample information to obtain samples of product 5. The proprietor of the sales environment can program machine-readable label writer 6 to write whatever product information they desire, such as information about related products, or even advertising material for the sales environment.

Customer 1 can continue to move about the sales environment stopping at various products 5. Machine-readable label 3 can read a store data for more than one product 5. Additionally, machine-readable label writer 6 can passively transmit information which may not be specifically requested by customer 1, depending upon how it is programmed. Machine-readable label 3 will passively receive information about various products as programmed by the proprietor of the sales environment.

In addition, machine-readable label writer 6 can be portable. This allows salespersons to transport portable machine-readable label writer 6 throughout the sales environment, for example when they ask customer 1 to try a product 5 in a remote location of the sales environment, data can be written on machine-readable label 3.

FIG. 1C depicts customer 1 exiting the sales environment with sample card 2 and incorporated machine-readable label 3. Customer 1 then brings machine-readable label 3 in range of a device for distributing samples 7, for example, a vending machine. Device for distributing samples 7 contains machine-readable label reader 9 for reading the machine-readable label 3. Customer 1 can either insert sample card 2 into an opening in device for distributing samples 7 or present machine-readable label 3 within range of machine-readable label reader 9 by any other means known in the art. Device for distributing samples 7 reads the data from machine-readable label reader 3, compares the data to a database containing sample information, and packages and distributes samples requested by customer 1 or passive written onto machine-readable label 3. This is shown in FIG. 1D where customer 1 receives packaged samples 10 upon exiting the sales environment. One advantage of the invention over the prior art is that customer 1 only retrieves samples written on machine-readable label 3 and only needs to transport sample card 2 though the sales environment, rather than having to carry distributed samples throughout the sales environment. In addition, device for distributing samples 7 packs the samples automatically in an attractive package 10 which may carry the sales environment's logo, graphics, and or messages.

FIG. 2 depicts device for distributing samples 7 in greater detail. Device for distributing samples 7 includes machine-readable label reader 9 that reads data stored on machine-readable label 3 incorporated in sample cards 2. This data passes to processor 11 that analyzes the data to determine which samples should be distributed. Processor 11 accesses database 12 to determine which samples correspond to the data read by machine-readable label reader 9. Processor 11 then directs sample selection/packaging mechanism 14 to select the appropriate samples from sample storage compartment 13.

Storage compartment 13 may include, for example, sub-compartments for storing various types of samples. Selection/packaging mechanism 14 may be able to select specific samples from storage compartment 13 using, for example, a robotic arm, or by selectively opening specific sub-compartments of storage compartment 13, thereby allowing the desired sample to drop into it.

Once a sample is selected and packaged by selection/packaging mechanism 14, it drops through dispenser 15 into a receptacle 8 from which a customer 1 can retrieve packaged sample 10.

Processor 11 can be programmed with very specific information about additional materials that should be packaged with sample in packaged sample 10. Additional materials may be stored in storage compartment 13, selected and packaged by selection packaging mechanism 14, and dispensed though dispenser 15. Processor 11 accesses database 12 to determine which additional materials correspond to the data read by machine-readable label reader 9. Processor 11 then directs sample selection/packaging mechanism 14 to select the appropriate additional materials and samples from sample storage compartment 13.

FIG. 3 depicts a flow chart of a method for dispensing at least one sample. In step 30, a customer 1 approaches a sample card dispenser 4 and takes a sample card 2 with an incorporated machine-readable label 3. In step 31, customer 1 approaches product 5. In step 32, customer 1 decides whether they desire a sample of product 5. If not, customer 1 returns to step 31 and approaches a different product 5. If, however, customer 1 does desire a sample of product 5, machine-readable label 3 in sample card 2 checks if it is receiving signals from a machine-readable label writer 6. If no signal is received, step 32 may be repeated, or customer 1 may continue to a different product 5 in step 31.

If a signal is detected in step 33, machine-readable label writer 6 transmits sample data to machine-readable label 3 in step 34. In step 35, customer 1 determines if they desire additional product samples. If yes, they return to step 31, and if not, customer 1 exits the sales environment in step 36 via an exit location. In step 37, customer 1 checks if a sample distribution device 7 is present at their exit location. If not, customer 1 is prompted to return to a different exit location to repeat steps 36 and 37. If a sample distribution device 7 is present at the customer's 1 exit location, step 38 prompts customer 1 to scan sample card 2 before machine-readable label reader 9. This step can be accomplished by any method known in the art. For example, customer 1 can insert sample card 2 into a slot to initiate machine-readable label reader 9. In addition, machine-readable label reader 9 may periodically search for signal transmissions from machine-readable labels and activate processor 11 upon receiving data

Step 49 determines whether a machine-readable label reader 9 reads machine-readable label 3. If not, step 38 repeats. If machine-readable label reader 9 reads machine-readable label 3, the sample data transmitted is recorded and/or stored by processor 11 in step 39. Processor 11 then compares the sample data with data stored in database 12 in step 40. In step 41, if the sample data is not found in database 12, step 39 is repeated to verify that data was not misread. If the sample data is found in step 41, processor 11 checks whether the sample in database 12 is in stock in storage compartment 13 in step 42. If the sample is not in stock, step 43 provides customer 1 with notification that the sample is out of stock. Step 43 can also provide customer 1 with a printout that can be redeemed for the sample at a later time, or via mail. If, however, processor 11 determines that the sample is in stock, processor 11 directs sample selection/packing mechanism 14 to select and retrieve the sample from storage compartment 13 in step 44.

In step 45, processor 11 verifies if additional packaging information is either transmitted by machine-readable label 3, or stored in database 12. If no additional packaging information is contained in either the transmitted sample data, or in database 12, selection/packaging mechanism 14 packages the sample in step 47. If processor 11 detects additional packaging information in step 45, processor 11 directs selection/packaging mechanism 14 to perform the instructions detected in step 46. These instructions can include, for example, adding additional advertising materials along with the sample, or adding additional samples not specifically selected by the user, but recommended in database 12. After processor 11 performs step 46 selection/packaging mechanism 14 packages the sample and any additional materials dictated by steps 45 and 46 and dispenser 15 distributes the sample package 10 to customer 1 in step 48.

FIG. 4 is a flow chart of a method of doing business including a procedure for distributing samples. In this embodiment, a proprietor of a sales environment can program a processor 11, or one or more machine-readable labels 3 to provide additional packaging information (i.e., in step 47 of FIG. 3) in step 51. In step 52, customer 1 performs steps 30-45 of FIG. 3. In step 53, device for distributing samples 7 packages at least one sample. In step 54, the device for distributing samples 7 includes at least one piece of additional information that will affect the sale of goods or services. For example, the additional information is an advertisement. Incorporated in the advertisement or the sample is a machine-readable label. The proprietor programs machine-readable label with information relating to a discount on a product, for example, a perfume (i.e., for which customer 1 requested a sample). The information can include product information, a coupon, or any other information that relates to the product or may affect the sale of that product or service.

Once customer 1 receives the advertisement information, he or she stores it onto a local memory, such as a PDA, or a cellular telephone in step 55. Alternatively customer 1 can simply receive the information in the form of an alpha-numeric code which, when presented in the sales environment, will be accepted to affect the sale of the relevant good or service.

Customer 1 then presents the information in the sales environment at a later time. This can occur by any known means of transmitting information, for example, through infrared signal transmission, by reciting an alpha-numeric code, or by presenting the seller with a machine-readable label. In step 56, the sales environment accepts the information and, in step 57, uses the information to affect the sale of a good or service. In this manner customer 1 can, for example, receive a sample while physically in a sales or service establishment and be able to take advantage of an discounts or offers the proprietor has provided along with the sample.

The preceding expressions and examples are exemplary and are not intended to limit the scope of the claims that follow.

What is claimed is:

1. A system for dispensing samples comprising:
a sample card distributor (4);
a machine-readable label (3);
a machine-readable label writer (6) for writing data associated with a product (5) onto the machine-readable label (3); and
a device for distributing samples (7) comprising:
a machine-readable label reader (9) for reading the machine-readable label (3);
a database (12) containing sample information;
means for packaging and distributing samples (14); and
a processor (110 for receiving data from the machine-readable label reader (9), obtaining sample information from the database (12), and directing the means for packaging and distributing samples to package and distribute at least one sample.

2. The system of claim 1, wherein said machine-readable label (3) includes a radio transponder or transmitter.

3. The system of claim 1, wherein the device for distributing samples (7) further comprises a vending machine.

4. The system of claim 1, wherein the means for packaging and distributing samples further comprises:
at least one storage compartment (13) for sorting and/or storing a sample;
a mechanism (14) for packaging the sample in a package;
means for retrieving the sample from the storage compartment and transporting it to the mechanism for packaging (14); and
a dispensing device (15) for dispensing a packaged sample (10).

5. The system of claim 1, wherein the processor (11) is programmable to receive data from the machine-readable label reader (9), obtain sample information from the database (12), and direct the means for packaging and distributing samples to package and distribute at least one sample.

6. The system of claim 1, wherein the processor (11) initiates the device for distributing samples (7) when the machine-readable label reader (9) reads data written on a machine-readable label (3).

7. A method for distributing samples comprising:
distributing a machine-readable label (3);
transporting the machine-readable label (3) through an environment;
writing data associated with a product (5) onto the machine-readable label (3);
reading the data written on the machine-readable label (3);
comparing the data written on the machine-readable label (3) to a database (12);
selecting at least one sample based on the comparing step;
packaging the at least one sample; and
distributing the at least one sample.

8. The method of claim 7, further comprising the steps of programming a processor (11) to initiate the reading step when at least one machine-readable label (3) is detected.

9. The method of claim 7, wherein the writing step further comprises writing information on the machine-readable label (3) upon a manual request.

10. The method of claim 7, wherein the writing step further comprises writing information on the machine-readable label (3) automatically.

11. The method of claim 7, wherein the selecting step further comprises selecting based on the comparing step and upon programmed commands for selecting packaging and distributing the at least one sample.

12. The method of claim 7, wherein the packaging step further comprises packaging the at least one sample with additional materials.

13. The method of claim 12, wherein the additional materials further comprise: advertising materials, coupons, promotional materials, graphics, messages, instructions for use, and/or additional sample cards.

14. A method of doing business comprising:
incorporating a machine-readable label (3) to a sample card (2);
writing data associated with a product (5) onto the machine-readable label (3);
reading the data from the machine-readable label (3);
comparing the data written on the machine-readable label (3) to a database (12);
selecting at least one sample based on the comparing step;
packaging the at least one sample;
distributing the at least one sample; and
affecting the sale of goods or services based on sample distributed and the data written on the machine-readable label (3).
